(19) United States
(12) Patent Application Publication
(10) Pub. No.: US 2007/0216542 A1
(43) Pub. Date: Sep. 20, 2007

(54) System and method for remotely tracking and monitoring a container and its contents

(76) Inventors: Jay Brosius, Frederick, MD (US); Rich Battista, Ashburn, VA (US)

Correspondence Address: LAW OFFICE OF DUANE S. KOBAYASHI, 1325 MURRAY DOWNS WAY, RESTON, VA, 20194, US

(21) Appl. No.: 11/639,425

(22) Filed: Dec. 15, 2006

Related U.S. Application Data
(63) Continuation-in-part of application No. 11/005,307, filed on Dec. 7, 2004.
(60) Provisional application No. 60/528,780, filed on Dec. 12, 2003.
(60) Provisional application No. 60/750,792, filed on Dec. 16, 2005.
(60) Provisional application No. 60/752,897, filed on Dec. 23, 2005.

(51) Int. Cl. G08G 1/123

(52) U.S. Cl. 340/989

(57) ABSTRACT

An asset tracking and monitoring system and method using a local network within a single shipment enclosure. In one embodiment, the local network includes a tag reader that is operative to retrieve data from tags that are affixed to cargo items that are loaded into the single shipment enclosure. Data retrieved via the local network is provided to a mobile terminal that communicates with a service operations center via a satellite communication link.

This application is a continuation-in-part of nonprovisional application Ser. No. 11/005,307, filed Dec. 7, 2004, which claims priority to provisional application No. 60/528,780, filed Dec. 12, 2003. This application also claims priority to provisional application No. 60/750,792, filed Dec. 16, 2005, and provisional application No. 60/752,897, filed Dec. 23, 2005. Each of the above-identified applications is incorporated herein by reference in its entirety.

### BACKGROUND

1. Field of the Invention

The present invention relates generally to monitoring and tracking and, more particularly, to a system and method for asset tracking and monitoring.

2. Introduction

Tracking mobile assets represents a growing enterprise as companies seek increased visibility into the status of movable assets (e.g., trailers, containers, etc.). Visibility into the status of movable assets can be gained through mobile terminals that are affixed to the assets. These mobile terminals can be designed to generate position information that can be used to update status reports that are provided to customer representatives.

One of the challenges in tracking assets is the tracking of cargo contained therein. What is needed therefore is a system and method for remotely tracking and monitoring a container and its contents.

### SUMMARY

A system and/or method for remotely tracking and monitoring a container and its contents, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of an asset tracking and monitoring system.

FIG. 2 illustrates a flowchart of an asset tracking and monitoring process.

FIG. 3 illustrates an embodiment of a local network.

FIG. 4 illustrates an embodiment of a single cargo shipment enclosure.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

One of the goals of asset tracking is maintaining continual visibility of an asset or its contents. A loss of visibility creates uncertainty in identifying a status. These uncertainties can contribute to an effective loss of control of the asset or its contents contained therein. As will be described, a flexible communication system can be designed to track and monitor an asset or its contents through various stages of travel.

In designing a monitoring framework that can maintain contact with an asset during all phases of travel from origin to destination, it has become apparent that a single monitoring mechanism may not be sufficient. In accordance with the present invention, a multi-mode asset monitoring capability is envisioned to provide high-availability coverage over a range of transport phases.

For example, satellite-based communications and positioning means operate with relatively small link margins and can therefore require relatively unimpaired paths from the terminal to the satellite. Such paths, however, may not be available in all instances (e.g., within container yards where assets are often stacked). Terrestrial mode communications also have their limitations. For example, cellular systems offer much better link margins than satellite communications means except in fringe and shadowed areas. However, once out of cellular coverage, terrestrial mode communication does not work. The unfortunate consequence is that terrestrial mode communications would not supply coverage over all phases of travel (e.g., mountain routes, rail routes, offshore shipping routes, etc.).

Notwithstanding the limitations of satellite and terrestrial communication systems, it is recognized that local monitoring networks also have unique strengths. In general, local monitoring networks can represent those networks that are largely directed to the local operating area of the supported operation, such as in a marine terminal, a truck terminal, aboard a ship, on a train, in a rail yard, in a shipping depot, in a tunnel, in a container, etc.

In one embodiment, the local network is designed to collect information from devices within the local area, process and screen the data, and present it to a communications node within the local area for routing to a remote central data collection facility. In this manner, a local wireless network simplifies communications at the operating site by enabling a single, central communications means from the site to the central facility. In various embodiments, this could be done by Internet, leased line, wireless telephone or data services (e.g., PCS), another satellite network, or a combination of the above.

It is a feature of the present invention that a local monitoring network can be used in combination with a wide area monitoring network (e.g., satellite) to produce a multi-mode solution. This multi-mode solution would facilitate complete coverage across an asset's travel route. In this framework, the local monitoring network can be used to report tracking and monitoring information to a central facility when out of contact with a satellite network, while the wide area satellite network can be used to report tracking and monitoring information to a central facility when out of contact with a local monitoring network. Here, each mode could use a different communications network to report asset position, status, and alert information. As would be appreciated, the various communications networks could have different performance characteristics, to thereby complement each other for a particular monitoring application.

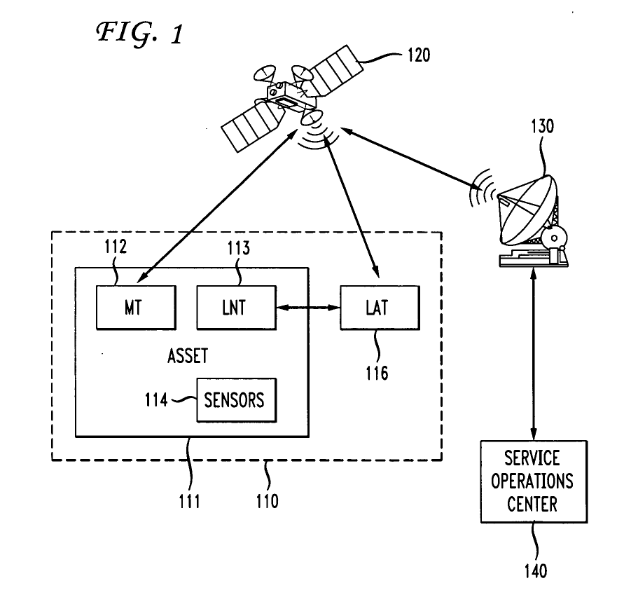

To illustrate the features of the present invention, reference is now made to the system diagram of FIG. 1. As illustrated, the system of FIG. 1 includes asset 111 that is contained within a local area 110 (e.g., ship, ship yard, rail yard, trailer yard, or the like). Position, status, and alert information can be communicated to service operations center (SOC) 140 via satellite 120 and antenna 130.

In one embodiment, SOC 140 is built around a relational database managing all relevant system, user, terminal, and transaction data. Several back end servers manage internal system functions, such as terminal and protocol management and position solving, while front-end servers manage applications and web delivery. SOC 140 can deliver information to customers in a number of ways, including by web account, URL query, XML data delivery (including the XML trailer tracking standard), email, and file transfer protocol (FTP).

As further illustrated in FIG. 1, asset 111 can include sensors 114 that are used to detect various conditions at asset 111. In various examples, sensors 114 can be used to detect intrusion, light, movement, heat, radiation, or any other monitoring characteristic. Events detected by sensors 114 are communicated to service operations center 140 using mobile terminal (MT) 112 and/or local network terminal (LNT) 113. It should be noted that while MT 112 and LNT 113 are illustrated as separate devices, they can be combined into a single multi-mode device. More generally, the multi-mode device can be designed to communicate in any number of modes dictated by a particular implementation.

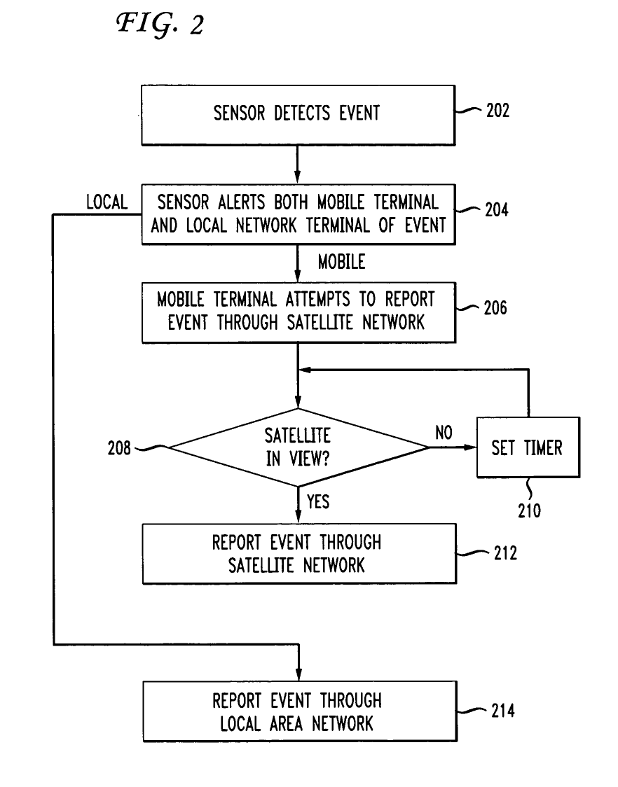

In general, MT 112 can be used to communicate tracking and monitoring information to SOC 140 directly via satellite 120. LNT 113, on the other hand, can be used to communicate tracking and monitoring information to SOC 140 through local area terminal (LAT) 116. In the embodiment illustrated in FIG. 1, LAT 116 would forward information communicated by LNT 113 to SOC 140 through satellite 120. In an alternative embodiment, LAT 116 can communicate information to SOC 140 using a leased line, Internet or other land-based connection scheme. The operation of the alternative communication paths reflected by MT 112 and LNT 113 is now described in greater detail with reference to the flowchart of FIG. 2.

As illustrated, the process begins, at step 202, with the detection by sensor 114 of an event. As noted, sensor 114 can be designed to detect various event conditions. As would be appreciated, asset 111 can be configured to include any number or combination of sensors depending on the particular monitoring application. Once sensor 114 detects an event, it would then alert at least one of MT 112 and LNT 113 at step 204.

In various embodiments, sensors 114 can be coupled directly to MT 112 and/or LNT 113. For example, if sensors 114 are coupled directly only to MT 112, then a connection may also be established between MT 112 and LNT 113, to thereby facilitate an effective connection between LNT 113 and sensors 114.

After MT 112 and/or LNT 113 have been alerted to the detected event, MT 112 and/or LNT 113 would then proceed to communicate the detected event information to SOC 140. Considering first MT 112, when any of sensors 114 activates, sensor 114 awakens MT 112 and causes it to enter a mode to report immediately on sensor status and activation. This process is represented by step 206 where MT 112 would attempt to report the event to SOC 140 through a direct connection to satellite 120. In one embodiment, MT 112 is represented by the MT developed by SkyBitz, Inc. for use in their Global Locating System (GLS). The GLS system is described in greater detail in U.S. Pat. No. 6,243,648, which is incorporated herein by reference in its entirety.

The combination of the protocol and MT design enables the MT to support scheduled position reports, MT paging (unscheduled requests for information from the MT), event reports (unscheduled, real time reporting of events detected by the MT), and low bandwidth data traffic. The MT can accommodate multiple simultaneous assignments, and can be configured remotely over the air. It also automatically adapts to changes in the network, and roams automatically among beams within a satellite footprint and among satellites. The GLS system is configured to use transponding satellites using the international geostationary L-band mobile satellite allocation.

Referring back to FIG. 2, if MT 112 determines that satellite 120 is not in view, it would then set a timer at step 210 for a short delay (e.g., seconds to minutes), go back to sleep, and reawaken when the timer expires to try again. When the timer has expired, the process would continue back to step 208, where MT 112 would again determine if satellite 120 is in view. This process will repeat until it is successful. In one embodiment, timer intervals will increase with successive failures to receive the satellite signal in order to conserve battery when blocked from satellite 120 for an extended period.

If MT 112 determines at step 208 that the satellite is in view, then MT 112 would then proceed to report the event to SOC 140 through satellite 120. In one embodiment, MT 112 reports the event by seeking an event timeslot or otherwise unoccupied timeslot (as evidenced by the forward link on that timeslot), and transmits a position and sensor status report over the corresponding return timeslot. It then proceeds to a slightly later timeslot to receive an acknowledgement. MT 112 will retry if it receives no acknowledgement.

As FIG. 2 further illustrates, a sensor alert provided to LNT 113 will also cause LNT 113 to report the event to SOC 140. This process is represented by step 214 where LNT 113 reports the event using a local area network. In one embodiment, LNT 113 receives the alert by sensor 114 directly. In another embodiment, LNT 113 is awakened by MT 112. Here, when MT 112 initially awakens due to a sensor alert, it can be designed to also close an appropriate contact controlling LNT 113 to alert LNT 113 as well of the event. In one embodiment, LNT 113 can then send “blinks”, or brief emissions, on an ongoing basis at regular settable intervals (e.g., up to four minutes) between blinks. If a sensor contact is closed, LNT 113 can immediately send a set of blinks with the change in status.

As illustrated in FIG. 1, LNT 113 can be generally designed to communicate with LAT 116 via a local network connection. LAT 116 can then proceed to communicate information generated by LNT 113 to SOC 140 via satellite 120. In one embodiment, LAT 116 is embodied as a similar unit to MT 112. In this embodiment, the primary difference between LAT 116 and MT 112 would be the item to which the units are fixed. MT 112 would be fixed to an asset being tracked and monitored, while LAT 116 would be fixed to an element within local area 110.

As would be appreciated, the specific method by which LNT 113 would communicate with LAT 116 would be implementation dependent. One embodiment of a communication mechanism between LNT 113 and LAT 116 is illustrated in FIG. 3. In this embodiment, location sensor 320 is operative to listen to emissions by tags 310, which are individually fixed to the plurality of container assets that are distributed in a local area 110. Location sensor 320 would then inform server 330 of the presence and status of tags 310 in local area 110. Any location sensor 320 able to hear tag 310 in turn reports the change in tag status to server 330. In one embodiment, several sensors 320 can be arranged around a local area 110 (e.g., ship yard, rail yard, ship, or the like) to locate each tag 310 using time difference of arrival techniques.

One example of tags 310 and location sensor 320 are the tags and location sensors manufactured by WhereNet, Inc. In general, WhereNet's local wireless locating and monitoring system has been used for locating and monitoring tags within a yard, depot, or plant environment. WhereNet's WhereTags operate in the 2.4 Ghz Industrial, Scientific, and Medical band, and can be set up to emit periodically from every few seconds to every few minutes. Tag emissions are spread spectrum, spread across 30 megahertz, and operate either at 2.5 milliwatts or 50 milliwatts, depending on the model. Each emission contains data on tag identity, tag state, the state of various sensor inputs, and other information. Emissions last only several milliseconds each, permitting very long battery life, up to seven years depending on type and report rate.

After server 330 collects reported information from tags 310, server 330 would then proceed to report this information back to SOC 140. In the illustrated embodiment, server 330 communicates with MT 340, which is operative to transmit information to the SOC via satellite 350.

In one embodiment, communication between server 330 and MT 340 is enabled using the local RS-485 data bus of MT 340. In general, the RS-485 data bus supports among other things an RS-485 interface to local digital devices. In this embodiment, the RS-485 interface is used to transport packets from server 330 to the SOC using satellite 350. Here, a software application hosted on server 330 extracts data from the database on server 330, formats it, adds the necessary RS-485 communications protocol layers, and deliver it to MT 340. At the SOC, application software would then extract the data from the incoming packets.

In one application, local area 110 is a single cargo shipment enclosure, such as an ISO shipping container, a bi-modal (truck/rail) container, dry box and refrigerated trailers and semi-trailers, rail cars, crates, and other enclosures for containing and shipping or hauling cargo. In this application, the local network monitors any cargo contained within the cargo shipment enclosure to observe loading, unloading, presence, any associated events, such as intrusions, temperature changes, motion, gas emissions, atomic emissions, heat emissions, or electromagnetic emissions, and data related to the cargo, such as manifests, hazards, shipment history, consignment and other shipment data.

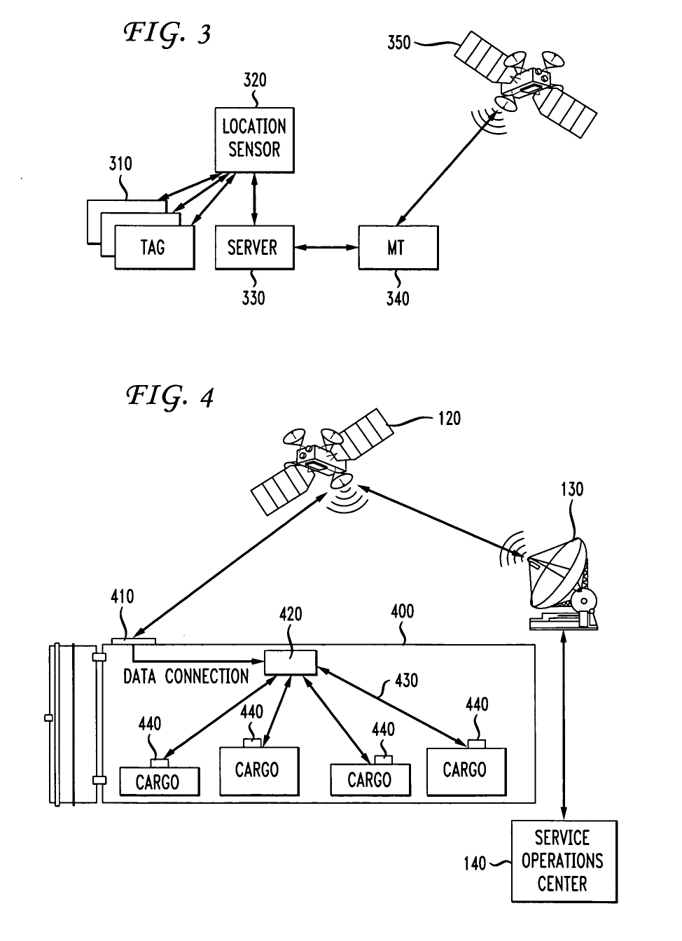

FIG. 4 illustrates an example of local network monitoring in the context of a single cargo shipment enclosure. As illustrated, tags 440 are attached or associated with each item of cargo to be shipped in cargo shipment enclosure 400. When cargo bearing these tags 440 enters cargo shipment enclosure 400, tag reader 420 in enclosure 400 observes the arrival of tag 440 and gathers relevant information regarding the associated cargo. The acquisition of this information is enabled through wireless link 430 that enables a probe/response. In general, tag reader 420 can be designed to report any changes in the environment of tag reader 420, including the arrival and departure of any tag 440, the data associated with tag 440, and any events associated with tag 440.

Tag reader 420 then forwards this information to mobile terminal 410 via a wired or wireless data connection. Mobile terminal 410 gathers this information for each item of monitored cargo, processes the information, and forwards the data received from the tag reader, or an abstraction of this data, to service operations center 140, where it is processed to provide useful information to a user.

In one embodiment, the local monitoring capability can be enabled by a radio frequency identification system (RFID), such as that implemented by SAVI or Symbol, Inc. In another embodiment, the local monitoring capability can be enabled by a real time locating system (RTLS), such as that implemented by WhereNet, Inc. In general, these capabilities include small RF tags attached to items, a tag reader used to interrogate the tags, and a processing system to process the data gathered.

In various examples, tags 440 can be designed to store information on the cargo itself, such as origin, destination, nature of the cargo, any hazardous conditions, and other shipment details. This information can be made available to tag reader 420 whenever tag 440 is read by tag reader 420. In one embodiment, tag 440 can also be coupled to one or more sensors that are designed to monitor some measurable aspect of the cargo item. Tag 440 can then be configured to report on any event associated with a coupled sensor.

Similarly, tag reader 420 can also be coupled to one or more sensors. In this embodiment, tag reader 420 would function to detect the presence of and read any tag 440 within cargo shipment enclosure 400 as well as monitor some measurable aspect within cargo shipment enclosure 400. For example, a sensor coupled to tag reader 420 can be designed to determine a fullness of cargo shipment enclosure 400. In general, sensors coupled to tag reader 420 can be designed to monitor some measurable element that has significance beyond a single cargo item.

Finally, mobile terminal 410 can also be coupled to one or more sensors. In various examples, the sensors can be designed to report on the status of cargo shipment enclosure 400, its doors, its environment such as temperature, humidity, radiation, gases, motion, orientation, or other environmental conditions or events.

As noted, mobile terminal 410 reports data (raw or processed) collected from tag reader, as well as data collected from its own sensors. These reports can be performed on a periodic basis, and/or when prompted either remotely or by a sensor event. Mobile terminal 410 can also report satellite observation data from which service operations center 140 can determine a position of mobile terminal 410. Alternatively, mobile terminal 410 can determine its own position. Regardless of its method of determination, the determined mobile terminal position can be associated with the sensor events or time of the report.

In one embodiment, tags can also be associated with a truck or a trailer. For example, a truck can be fitted with a monitoring element that can acquire identity information from a tag mounted on a identifier, or conversely a trailer can be fitted with a monitoring element that can acquire identity information from a tag mounted on a truck. In one embodiment, data is transmitted to the operations center only when a change occurs, for example, when a new or different truck/trailer combination is detected.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. An asset monitoring system, comprising:
a data collection and forwarding device at a single shipment enclosure within which a plurality of cargo items reside, said data collection and forwarding device being configured to receive data from a monitoring element fixed to a first of said plurality of cargo items;
a satellite transceiver stationed affixed to said single shipment enclosure, said satellite transceiver being configured to receive said data from said data collection and forwarding device; and
a data center in communication with said satellite transceiver via a satellite communication link, said data center being configured to receive said data from said satellite transceiver.

2. The system of claim 1, wherein said location is one of a shipping container, a trailer, a crate and a rail car.

3. The system of claim 1, wherein said data collection and forwarding device is a tag reader.

4. The system of claim 1, wherein said monitoring element is a tag.

5. The system of claim 1, wherein said monitoring element is read by said data collection and forwarding device at a time proximate to loading of a cargo item to which it is fixed into said single shipment enclosure.

6. The system of claim 1, wherein said monitoring element reports data about a cargo item to which it is fixed.

7. The system of claim 1, wherein said monitoring element is coupled to a sensor.

8. The system of claim 1, wherein said data collection and forwarding device is coupled to a sensor.

9. The system of claim 1, wherein said satellite transceiver is coupled to a sensor.

10. The system of claim 1, wherein said satellite transceiver also transmits position data derived from a reception of GPS satellite signals.

11. A monitoring method in a single shipment enclosure, comprising:
detecting a presence of a tag that is affixed to a cargo item being loaded into the single shipment enclosure;
receiving a report from said tag, said report including data about said cargo item; and
transmitting said report to a satellite transceiver affixed to the single shipment enclosure, said satellite transceiver being configured to transmit data derived from said report to a remote service operations center.

12. The method of claim 11, wherein said tag is a radio frequency identification tag.

13. The method of claim 11, wherein said transmitting comprises transmitting via a wireless connection.

14. The method of claim 11, wherein said transmitting comprises transmitting via a wired connection.

15. A monitoring method in a single shipment enclosure, comprising:
receiving, in a mobile terminal affixed to the single shipment enclosure, signals from a plurality of GPS satellites;
receiving, in said mobile terminal, data from a tag reader, said tag reader being configured to wirelessly retrieve data from one or more tags that are affixed to cargo items being loaded into the single shipment enclosure; and
transmitting, by said mobile terminal, one or more reports to a service operations center, said one or more reports including position data derived from said signals received from said plurality of GPS satellites and cargo item data derived from said data received from said tag reader.

16. The method of claim 15, wherein said transmitting comprises transmitting a scheduled report.

17. The method of claim 15, wherein said transmitting comprises transmitting in response to a request from said service operations center.

18. The method of claim 15, wherein said transmitting comprises transmitting in response to a detected event.

19. The method of claim 18, wherein said transmitting comprises transmitting in response to an event detected by a sensor coupled to said mobile terminal.

20. The method of claim 18, wherein said transmitting comprises transmitting in response to an event detected by a sensor coupled to said tag reader.
